(19) United States
(12) Patent Application Publication
(10) Pub. No.: US 2011/0141517 A1
(43) Pub. Date: Jun. 16, 2011

(54) PRINTING APPARATUS AND PRINTING SYSTEM

(75) Inventor: Katsuhito Yokoyama, Kita-ku (JP)

(73) Assignee: Konica Minolta Business Technologies, Inc., Chiyoda-ku (JP)

(21) Appl. No.: 12/960,944

(22) Filed: Dec. 6, 2010

(30) Foreign Application Priority Data
Dec. 16, 2009 (JP) 2009-285542

(51) Int. Cl. G06F 3/12

(52) U.S. Cl. 358/1.15

(57) ABSTRACT

Disclosed is a printing system in which any one of plural printers implements a print job outputted by a print instructing apparatus, without employing an exclusive apparatus that controls the plurality of printers so as to determine a processing destination printer. The printer serving as one of the plural printers acquires a print job stored in a storage device and is capable of implementing the print job. The storage device stores the print job received from the print instructing apparatus, therein, and receives accesses from the plural printers. The printer includes: a detecting section to access to the storage device so as to detect the print job stored in the storage device; an acquiring section to acquire the print job detected by the detecting section from the storage device; and a processing section to implement the print job acquired by the acquiring section.

This application is based on Japanese Patent Application NO. 2009-285542 filed on Dec. 16, 2009, with Japan Patent Office, the entire content of which is hereby incorporated by reference.

### BACKGROUND OF THE INVENTION

The present invention relates to a printing apparatus to be employed for such a printing system that implements a print job, instructed by a print instruction apparatus, in any one of a plurality of printing apparatuses, and relates to the printing system concerned.

As set forth in Tokkaihei 10-116165 (Japanese Patent Application Laid-Open Publication), in a conventional printing system that implements a print job, transmitted from a computer coupled to a network, in any one of a plurality of printers coupled to the network concerned, for instance, in order to heighten a processing efficiency of the whole system, a server (print server) is installed onto the network so as to make it possible that the server once stores the print job (print data) sent from the computer concerned therein, and then, inquire an operating status and printer information from each of the printers, coupled to the network concerned, to determine a transmitting destination (a printer to be in charge of implementation) of the print job concerned.

According to the conventional technology abovementioned, a server should be installed onto the network, and it is also necessary to install an exclusive control program into the server. As a result, there has arisen such a problem that the cost for introducing the system has considerably increased. Further, when a printer is added or deleted to/from the network system, it is necessary to conduct the setting change of the printer control information, etc. As a result, there has arisen such another problem that the complexity of the system management operation has considerably increased.

### SUMMARY OF THE INVENTION

To overcome the abovementioned drawbacks in conventional printing systems, it is one of objects of the present invention to provide a printing apparatus and a printing system, which make it possible to construct such a configuration in which any one of a plurality of printers implements a print job outputted by a print instructing apparatus, without employing an exclusive apparatus that manages the plurality of printers and the print job sent from the print instructing apparatus so as to determine a specific printer serving as the processing destination site of the print job concerned.

Accordingly, at least one of the objects of the present invention can be attained by any one of the printing apparatuses and the printing systems described as follows.

(1) According to a printing apparatus reflecting an aspect of the present invention, the printing apparatus serving as one of plural printing apparatuses, each of which acquires a print job stored in a storage device and is capable of implementing the print job, wherein the storage device stores the print job received from a print instructing apparatus, and receives accesses from the plural printing apparatuses, the printing apparatus comprises: a detecting section to access to the storage device so as to detect the print job stored in the storage device; an acquiring section to acquire the print job detected by the detecting section from the storage device; and a processing section to implement the print job acquired by the acquiring section.
(2) According to another aspect of the present invention, in the printing apparatus recited in item 1, the acquiring section determines whether or not the print job, detected by the detecting section, is to be implemented by the processing section.
(3) According to still another aspect of the present invention, in the printing apparatus recited in item 2, the acquiring section finds a suitability level in a case that the processing section implements the print job detected by the detecting section, so as to employ the suitability level for determining whether or not the print job, detected by the detecting section, is to be implemented by the processing section.
(4) According to still another aspect of the present invention, in the printing apparatus recited in item 3, the acquiring section writes the suitability level into the storage device, and compares the suitability level with other suitability levels written into the storage device by other ones of the plural printing apparatuses, so as to determine whether or not the print job, detected by the detecting section, is to be implemented by the processing section; and, when determining that the suitability level is higher than the other suitability levels, the acquiring section acquires the print job, detected by the detecting section, from the storage device.
(5) According to still another aspect of the present invention, in the printing apparatus recited in item 3, the acquiring section compares the suitability level with a predetermined reference level, so as to determine whether or not the print job, detected by the detecting section, is to be implemented by the processing section; and, when determining that the suitability level is higher than the predetermined reference level, the acquiring section acquires the print job, detected by the detecting section, from the storage device.
(6) According to still another aspect of the present invention, in the printing apparatus recited in item 3, the processing section includes: a printing section that implements a print processing operation to print an image, based on the print job, onto a recording medium, so as to output a printed recording medium onto which the image is printed; and a post processing section that implements a post processing operation to apply a post processing, based on the print job, to the printed recording medium outputted by the printing section; and the suitability level includes a first suitability level in regard to the print processing operation and a second suitability level in regard to the post processing operation.
(7) According to still another aspect of the present invention, in the printing apparatus recited in item 3, the print job includes processing conditions that specify processing contents of the print job concerned, and the processing conditions include a non-indispensable selecting condition, for which a setting operation to be conducted by the print instructing apparatus is acceptable; and the acquiring section finds the suitability level, based on the non-indispensable selecting condition included in the processing conditions of the print job and a function of the processing section.
(8) According to still another aspect of the present invention, in the printing apparatus recited in items 1, the detecting section accesses the storage device at such a timing when the processing section can implement a new job.
(9) According to still another aspect of the present invention, in the printing apparatus recited in anyone of items 1-8, the acquiring section instructs the storage device to delete the print job, acquired in advance by the acquiring section, from the storage device.
(10) According to still another aspect of the present invention, in the printing apparatus recited in anyone of items 1-9, the printing apparatus is provided with the storage device.
(11) According to a printing system reflecting still another aspect of the present invention, the printing system, comprises: a print instructing apparatus that outputs a print job; a storage device that receives the print job, outputted by the print instructing apparatus, so as to store the print job received, therein; a plurality of printing apparatuses, each of which is capable of accessing the storage device to acquire the print job stored in the storage device and of implementing the print job, and each of which comprises a detecting section to access to the storage device so as to detect the print job stored in the storage device, an acquiring section to acquire the print job detected by the detecting section from the storage device, and a processing section to implement the print job acquired by the acquiring section, wherein the acquiring section conducts a determining operation for determining whether or not the print job, detected by the detecting section, is to be implemented by the processing section; and a control section, which is provided in either the print instructing apparatus or each of the plurality of printing apparatuses, to display a single or plural result/results of the determining operation that has been conducted for the print job, stored in the storage device, by at least one of the plurality of printing apparatuses, with information thereof, so as to make the print instructing apparatus accept a user's selecting operation for selecting a printing apparatus that implements the print job from the single or plural result/results, and to make the storage device store a result of the user's selecting operation therein; wherein, among the printing apparatuses that conducted the determining operation, a specific printing apparatus, which has confirmed that the specific printing apparatus has been selected from the result of the user's selecting operation stored in the storage device, acquires the print job detected by the detecting section from the storage device.
(12) According to still another aspect of the present invention, in the printing system recited in item 11, the acquiring section finds a suitability level in a case that the processing section implements the print job detected by the detecting section, so as to employ the suitability level for determining whether or not the print job, detected by the detecting section, is to be implemented by the processing section.
(13) According to yet another aspect of the present invention, in the printing system recited in item 11, the control section makes the print instructing apparatus display information of a printing apparatus that fulfills a predetermined condition among the printing apparatuses that conducted the determining operation.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic diagram indicating a configuration of a printing system embodied in the present invention as the first embodiment;

FIG. 2 shows a block diagram indicating a configuration of a printer embodied in the present invention as the first embodiment;

FIG. 3 shows a schematic diagram indicating a post processing screen to be displayed as a printer driver function selection screen embodied in the present invention as the first embodiment;

FIG. 4 shows a schematic diagram indicating a contact address screen to be displayed as a printer driver function selection screen embodied in the present invention as the first embodiment;

FIG. 5 shows a schematic diagram indicating a data structure of a profile embodied in the present invention as the first embodiment;

FIG. 6 shows a table indicating examples of addition points in regard to a printing velocity, according to a processing suitability level calculating method embodied in the present invention as the first embodiment;

FIG. 7 shows a table indicating exemplified functions (efficiencies) of printers embodied in the present invention as the first embodiment, and suitability levels corresponding to a print job;

FIG. 8 shows a functional block diagram indicating functions of software (programs) installed in each of apparatuses coupled to printing system embodied in the present invention as the first embodiment;

FIG. 9 shows a flowchart indicating flows of operations to be conducted by each of apparatuses constituting a printing system embodied in the present invention as the first embodiment;

FIG. 10 shows a flowchart indicating a subroutine of a profile read processing indicated in the flowchart shown in FIG. 9;

FIG. 11 shows a flowchart indicating a subroutine of a suitability level establishment processing indicated in the flowchart shown in FIG. 9;

FIG. 12 shows a flowchart indicating a subroutine of a profile write processing indicated in the flowchart shown in FIG. 9;

FIG. 13 shows a schematic diagram indicating an example of a printer selection screen embodied in the present invention as the first embodiment;

FIG. 14 shows a flowchart indicating a subroutine of a profile confirmation suitability determination processing indicated in the flowchart shown in FIG. 9;

FIG. 15 shows a functional block diagram indicating functions of software (programs) installed in each of apparatuses coupled to printing system embodied in the present invention as the second embodiment; and

FIG. 16 shows a flowchart indicating flows of operations to be conducted by each of apparatuses constituting a printing system embodied in the present invention as the second embodiment.

### DETAILED DESCRIPTION OF THE PREFERRED EMBODIMENT

Referring to the drawings, the embodiments of the present invention will be detailed in the following.

### First Embodiment

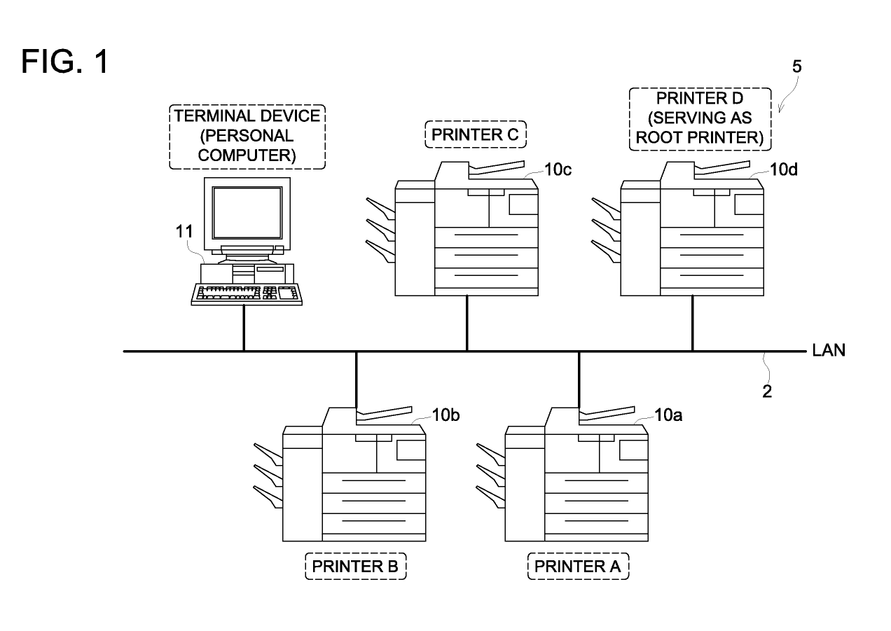

FIG. 1 shows a schematic diagram indicating a printing system 5 embodied in the present invention as the first embodiment. The printing system 5 is constituted by a plurality of printers 10, an arbitral number of terminal devices 11 that access the plurality of printers 10, and a network 2, such as a LAN (Local Area Network), etc., through which the plurality of printers 10 and the terminal devices 11 are coupled to each other. The printing system 5 is so constituted that a print job inputted from any one of the terminal devices 11 is implemented in any one of the plurality of printers 10. The printing system 5, exemplified as the first embodiment to be detailed in the following, is provided with four printers 10a, 10b, 10c and 10d.

Each of the terminal devices 11 (hereinafter, referred to as a terminal device 11) can access each of the plurality of printers 10 (hereinafter, referred to as a printer 10) through the network 2, so as to conduct operations for instructing and requesting various kinds of operations, such as a document printing, etc. For instance, the terminal device 11 is structured by installing various kinds of application programs, such as a printer driver (driver program), an E-mail program, etc., into the personal computer.

The user operates the terminal device 11 to designate the document to be printed, and to established various kinds of processing conditions (parameters and setting values) and set a printer information display selection as needed, so as to input printing instructions, to be transmitted to the printer 10, from the terminal device 11. For instance, the various kinds of processing conditions includes a print size (size of printing paper sheet), a one side or duplex printing, an integration printing (N-in-1 printing), a monochrome or color printing, a number of copies, finish settings, etc. In this connection, a processing condition that is not instructed by the user is set at its initial default value. Further, hereinafter, the printer information display selection is defined as such a user selection mode that displays the suitability degrees (suitability levels) of the plurality of printers 10 with respect to the print job instructed by the user, etc., on the terminal device 11, so as to make it possible for the user to select a specific printer to be set as the processing destination of the print job concerned from the plurality of printers 10.

Receiving the abovementioned operations conducted by the user, the printer driver installed in the terminal device 11 creates a print job that includes a profile in regard to the print job concerned and print data (PDL (Page Description Language) data), and the terminal device 11 transmits the print job to the printer 10 predetermined. The profile includes the information for determining the processing destination of the print job (a part of processing conditions), a presence or absence of the printer selecting information display screen, an address of the terminal device 11 concerned, etc. Further, the print data includes a document name (name of the print job), processing conditions, etc. The predetermined one of the plurality of printers 10 that receives the print job is defined as a “root printer”, and the printer 10d is established as the root printer in the first embodiment.

The printer 10 (each of the four printers 10a, 10b, 10c and 10d) is provided with a printing function for printing an image represented by the print job (print data) transmitted from the terminal device 11 onto a recording paper sheet and outputting the printed recording paper sheet, a post processing function for applying finish processing to the recording paper sheet printed and outputted, an E-mail function for transmitting and receiving an E-mail, etc. The operation for processing the print job (job processing) is implemented by employing the printing function, while the post processing is implemented by employing the post processing function. The post processing includes, for instance, a punch processing (PUNCH), a staple processing (STAPLE), a fold processing (FOLD), etc.

In this connection, it is applicable that the job processing functions (efficiencies) provided in the four printers 10a, 10b, 10c and 10d are either the same as each other or different from each other. For instance, it is applicable that the printing velocities and the kinds of post processing are either the same or different among them.

Further, a root functional section is activated in the printer 10d established as the root printer. The root functional section is provided with such a function for storing the print job received from the terminal device 11 into a predetermined storage area. The predetermined storage area is configured as a common storage area (common folder) to which all of the four printers 10a through 10d and the printer drivers of the terminal devices 11 are accessible.

Still further, the printer 10 (each of the four printers 10a, 10b, 10c and 10d) is provided with a detecting function for accessing the predetermined storage area to detect a print job stored therein, an acquiring function for acquiring the detected print job from the predetermined storage area, and an implementing function for implementing the print job acquired. One of print jobs stored in the predetermined storage area is implemented by any one of the plurality of printers 10 that accesses the predetermined storage area.

Concretely speaking, the printer 10 (each of the four printers 10a, 10b, 10c and 10d) is provided with: the detecting function for accessing the predetermined storage area at the time of “Ready status” (at the timing when a new print job can be implemented) to detect a print job stored therein; a finding function for finding a suitability level when the print job concerned is implemented in the printer 10 concerned, based on the profile of the detected print job; a writing function for writing the suitability level into the profile; a comparing function for comparing the suitability level of the concerned printer 10 with that of the other printer 10, so as to determine whether or not the concerned print job should be implemented within the concerned printer 10; and a determining function for determining that the concerned print job should be implemented within the concerned printer 10 when the suitability level of the concerned printer 10 is higher than that of the other printer 10, and acquiring the concerned print job from the predetermined storage area so as to implement the concerned print job.

The printer driver installed into the terminal device 11 is provided with: a function for accessing the profile stored in the predetermined storage area of the printer 10d, so as to read the information in regard to the printer 10, into the profile of which the suitability level is written, from the profile concerned, and then, displaying the suitability level on a display section of the terminal device 11; another function for accepting an operation for selecting a specific printer, which implements the print job concerned, from the printers displayed on the display section (user's selection); and still another function for writing the result of the selection into the profile. The information in regard to the printer includes printer information, such as a name of printer (printer name), a printing velocity, functions for processing print job, etc., and a suitability level.

Still further, with respect to the print job for which a presence of the printer information display selection is established, the printer 10 (each of the four printers 10a, 10b, 10c and 10d) is provided with a function for again accessing the profile after the suitability level of the own printer abovementioned is written into the profile so as to confirm the result of the selection (user's selection) written in the profile, and determining that the concerned print job is to be implemented within the own printer, when the own printer is selected, and then, acquiring the concerned print job from the printer 10d to implement the acquired print job. Yet further, the printer 10 (each of the four printers 10a, 10b, 10c and 10d) is provided with a function for notifying the contacting point, included in the profile, of the name of the print job concerned and the information (printer name, etc.) of the own printer serving as the processing destination (printout destination site).

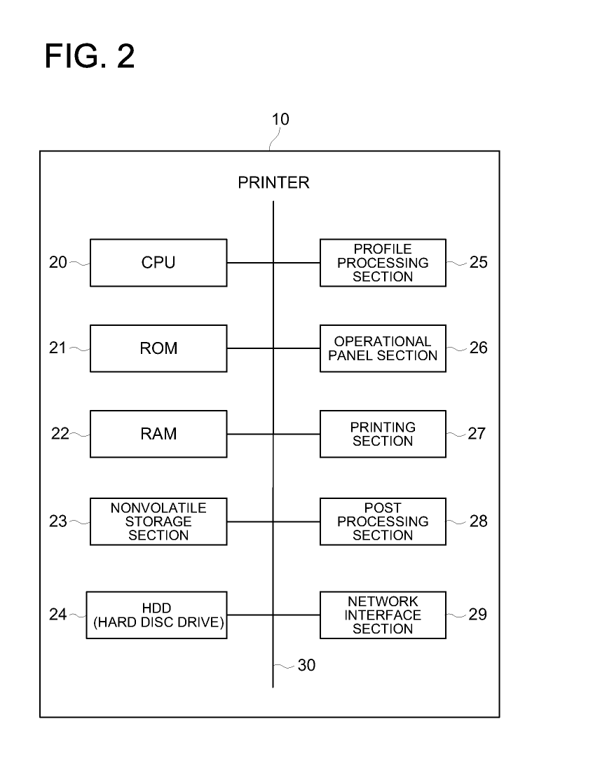

FIG. 2 shows a block diagram indicating a rough configuration of the printer 10. Since the fundamental configurations of the four printers 10a, 10b, 10c and 10d are substantially the same as each other even if some differences exist between the job processing functions of them, hereinafter, the rough configuration of the printer 10 (corresponding to each of the four printers 10a, 10b, 10c and 10d) will be detailed in the following by employing a single block diagram shown in FIG. 2.

The printer 10 is constituted by a CPU (Central Processing Unit) 20 that serves as a control section, a ROM (Read Only Memory) 21, a RAM (Random Access Memory) 22, a nonvolatile storage section 23, an HDD (Hard Disc Drive) 24, a profile processing section 25, an operational panel section 26, a printing section 27, a post processing section 28, a network interface section 29, etc., which are coupled to each other through a bus 30.

The CPU 20 controls various kinds of operations to be conducted in the printer 10 by executing the programs stored in the ROM 21. In the specific printer 10 that is established as the root printer (printer 10d in the present embodiment), the CPU 20 also serves as a root functional section. The RAM 22 is used as not only a working memory for temporarily storing various kinds of data when the CPU 20 executes the programs, but also an image memory for temporarily storing a print job therein. In the specific printer 10 that is established as the root printer, the print job received from the terminal device 11 is stored in the predetermined storage area provided in the RAM 22.

The nonvolatile storage section 23 is such a storage device that retains stored information even if the power supply is turned OFF, and stores information being inherent to the apparatus concerned, various kinds of setting information, etc., therein. The information, being inherent to the apparatus concerned, includes an apparatus ID (IDentification), a name of own printer (printer name), a printing velocity of own printer, kinds of post processing provided in the own printer, etc. The HDD 24 stores various kinds of storing data, and also inputted image data (print data), etc., therein.

The profile processing section 25 conducts various kinds of processing operations, including operations for reading (readout) and writing data in regard to the profile of the print job, another operation for parsing the profile, still other operations for calculating and determining the suitability level based on the profile, yet another operation for determining the suitability of the own printer in respect to the print job concerned, etc.

The operational panel section 26 displays various kinds of screens, such as an operational screen, a setting screen, a guidance screen, etc., and accepts various kinds of inputting operations conducted by the user. For instance, the operational panel section 26 is constituted by a display section including an LCD (Liquid Crystal Display), etc., a touch panel mounted over the display section so as to detect coordinate values of the point depressed by the user, various kinds of buttons, etc.

The printing section 27 forms an image, represented by the print data (image data) included in the print job, onto a recording paper sheet through the electro-photographic process, in order to output the recording paper sheet having the image formed thereon. For instance, the printing section 27 is configured as, so called, a laser printer that is typically constituted by: a conveyance mechanism for conveying the recording paper sheet; a photoreceptor drum; a charging device; an LD (Laser Diode) that emits a laser beam, intensity of which is modulated on the basis of the inputted image data a scanning unit for scanning the laser beam, emitted from the LD, onto the circumferential surface of the photoreceptor drum; a developing device; a transferring separation device; a cleaning device; and a fixing device. It is also applicable that, other than the laser printer abovementioned, an LED (Light Emitting Diode) printer in which, instead of the laser beam, a plurality of lights respectively emitted from a plurality of LEDs are irradiated onto the photoreceptor drum, or any other type printer is employed as the printing section 27.

The post processing section 28 applies a post processing to the recording paper sheet outputted in the state of having the image printed by the printing section 27 thereon. The network interface section 29 serves as an interface to communicate with the terminal devices 11, the other printers 10, a server, etc., through the network 2.

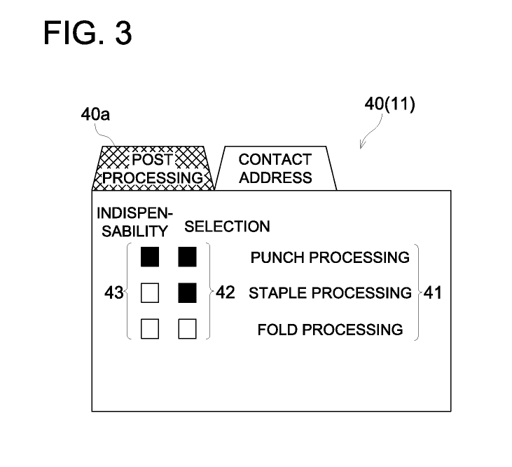

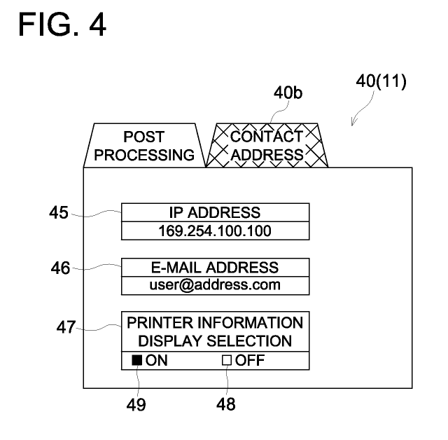

FIG. 3 and FIG. 4 show schematic diagrams indicating an example of a printer driver function selection screen 40 displayed on the terminal device 11. The printer driver function selection screen 40 is displayed on the display section of the terminal device 11 by the printer driver installed in the terminal device 11.

FIG. 3 shows the schematic diagram indicating an example of a post processing screen 40a to be displayed within the printer driver function selection screen 40. In the post processing screen 40a, post processing names 41 indicating kinds of post processing provided in the printer 10 as applicable post processing items, first selection boxes 42 for accepting the user's clicking operation to select either selection or non-selection of each of the concerned post processing items (establishment or non-establishment as the selecting condition), and second selection boxes 43 for accepting the user's clicking operation to select either indispensability or non-indispensability of each of the concerned post processing items (establishment or non-establishment as the indispensable condition) are displayed. When the user selects the “non-selection” (turns OFF the selection), concerned one of the first selection boxes 42 is displayed as a blank box, while, when the user selects the “selection” (turns ON the selection), concerned one of the first selection boxes 42 is filled with a high density solid color. Further, when the user selects the “non-indispensability” (turns OFF the indispensability), concerned one of the second selection boxes 43 is displayed as a blank box, while, when the user selects the “indispensability” (turns ON the indispensability), concerned one of the second selection boxes 43 is filled with a high density solid color.

In the present embodiment, the three kinds of post processing items, including the “PUNCH” representing the punch processing, the “STAPLE” representing the staple processing and the “FOLD” representing the fold processing, are displayed as the post processing names 41. In this connection, even if every one of all of the four printers 10a, 10b, 10c and 10d is not necessary provided with the three kinds of post processing items abovementioned, those three kinds of post processing items are displayed in the post processing screen 40a, as far as at least one of the four printers 10a, 10b, 10c and 10d is provided with all of them. Further, the exemplified schematic diagram shown in FIG. 3 indicates such a state that the punch processing and the staple processing, the first selection boxes 42 of which are filled with the high density solid color, is currently selected (selected as the selecting conditions), and the punch processing, the second selection box 43 of which is filled with the high density solid color, is currently made to be indispensable (established as the “indispensable item”).

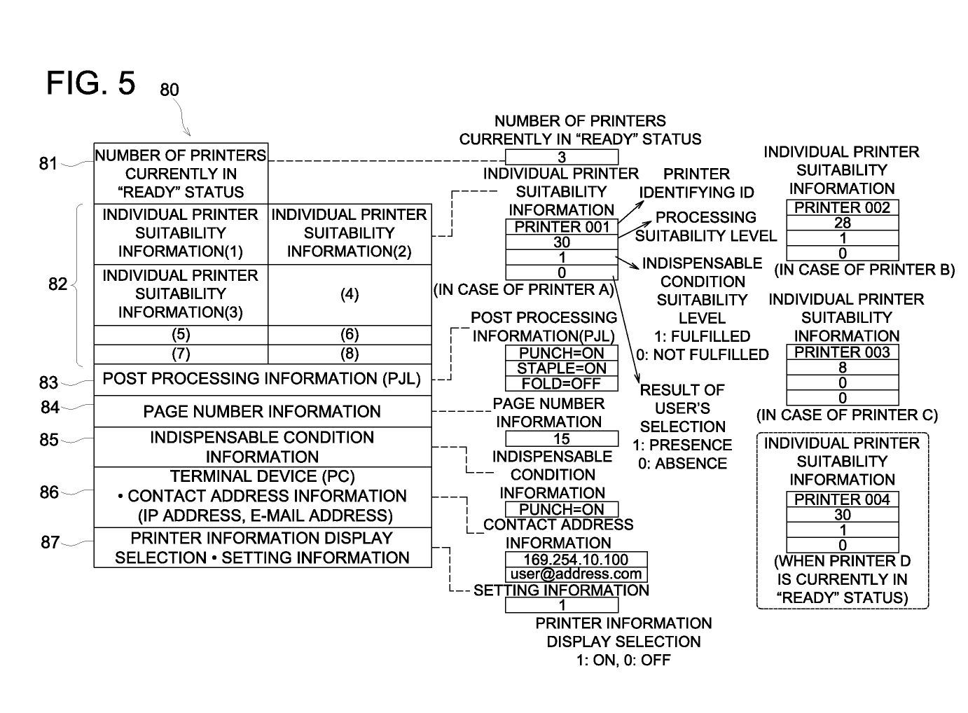

Through the post processing screen 40a, it is possible for the user to select the post processing items to be applied to the print job under the user's print instruction and to establish the indispensability of each of the post processing items selected by the user. Receiving the results of the selection and the establishment abovementioned, the printer driver stores the information representing the selection or non-selection of each of the concerned post processing items (setting value, such as “selection”=ON, “non-selection”=OFF, etc.), and the other information representing the indispensability or non-indispensability of each of the concerned post processing items (setting value, such as “indispensability”=ON, “non-indispensability”=OFF, etc.) into the profile of the print job concerned, as information representing the processing conditions in regard to the post processing. Further, the printer driver also stores page number information representing a number of printing pages, included in the processing conditions in regard to the print processing, into the profile being same as the abovementioned (refer to FIG. 5).

FIG. 4 shows a schematic diagram indicating an example of a contact address screen 40b to be displayed within the printer driver function selection screen 40. In the contact address screen 40b, three columns, including an IP (Internet Protocol) address column 45 serving as an input and display area of an IP address of the terminal device 11, an E-mail address column 46 serving as another input and display area of an E-mail address of the terminal device 11 (E-mail address of the user who uses the terminal device 11 concerned) and a printer information display selection column 47 for accepting the establishment of the printer information display selection, are displayed. In the printer information display selection column 47, two selection boxes, including an OFF selection box 48 for accepting the user's clicking operation to turn OFF the printer information display selection (box indicated as “OFF” in FIG. 4) and an ON selection box 49 for accepting the user's clicking operation to turn ON the printer information display selection (box indicated as “ON” in FIG. 4), are displayed. When the printer information display selection is established as OFF state (at the time of non-establishment), the OFF selection box 48 is filled with a high density solid color, while the ON selection box 49 is displayed as a blank box. On the other hand, when the printer information display selection is established as ON state (at the time of establishment), the ON selection box 49 is filled with a high density solid color, while the OFF selection box 48 is displayed as a blank box. Further, the exemplified schematic diagram shown in FIG. 4 indicates such a state that the printer information display selection is turned ON (established as the “establishment” state)

Through the contact address screen 40b, it is possible for the user to conduct an operation for setting the IP address and the E-mail address of the terminal device 11 serving as the contact site of the print job, which issues the printing instruction, and another operation for establishing the presence or absence (ON or OFF) of the printer information display selection in regard to the print job concerned. Receiving the abovementioned setting results, the printer driver stores the IP address and the E-mail address serving as information representing the contact address of the terminal device 11 (contact address information) and other information representing the setting information of the printer information display selection (setting value, such as ON=1 or OFF=0, etc.) into the profile of the print job concerned (refer to FIG. 5).

FIG. 5 shows a schematic diagram indicating a data structure of a profile 80 and examples of data to be stored in the profile 80.

The profile 80 is provided with: a printer number information storing area 81 into which information representing a number of printers that are currently in the “Ready” state (number of accessible printers) is stored; a plurality of (a predetermined number of) suitability information storing areas 82 into each of which information representing the suitability information of the corresponding printer (individual printer suitability information) is stored; a post processing information storing area 83 into which post processing information (written in the PJL (Printer Job Language)) representing the selection or non-selection of the post processing is stored; a page number information storing area 84 into which page number information representing a number of printing pages included in the print job concerned is stored; an indispensability condition information storing area 85 into which indispensability condition information representing an indispensability or non-indispensability of the post processing is stored; an contact address information storing area 86 into which contact address information (IP address and E-mail address) of terminal device 11 is stored; and a display selection setting information storing area 87 into which setting information of the printer information display selection is stored.

The individual printer suitability information includes the aforementioned suitability level of the printer 10 in respect to the print job concerned. The suitability level is defined as a processing suitability level in regard to the job processing, and an indispensable condition suitability level in regard to the indispensable condition. In the present embodiment, the processing suitability level is calculated by regarding the printing velocity and the post processing as the calculation objects. Accordingly, among the plural kinds of processing conditions for the print job, the page number information and the post processing information, which are necessary for calculating the processing suitability level, are stored into the profile 80. Further, the indispensable condition information, which is necessary for determining the indispensable condition suitability level, is also stored into the profile 80.

The details of the individual printer suitability information includes (1) a printer ID (Identification), (2) printer information (not shown in the drawings), (3) a processing suitability level, (4) an indispensable condition suitability level and (5) a user selection result. The printer 10 (any one of four printers 10a, 10b, 10c and 10d), currently accessed, writes the abovementioned items (1) through (4) into the profile 80. Among them, with respect to (3) the processing suitability level, the number of points, calculated by the concerned printer itself; is written into the profile 80, while, with respect to (4) the indispensable condition suitability level, the information (determination value, such as “fulfill”=1 or “not fulfill”=0, etc.), representing the result determined by the concerned printer itself, is written into the profile 80. Further, with respect to (5) the user selection result, the other information (selection value, such as “presence of selection”=1 or “absence of selection”=0, etc.), representing the result of the user's selection is written into the profile 80 by the terminal device 11 concerned.

For instance, when the settings, indicated in the post processing screen 40a shown in FIG. 3 and the contact address screen 40b shown in FIG. 4, are established, the post processing information, such as “PUNCH=ON”, “STAPLE=ON”, “FOLD=OFF”, etc., are stored into the post processing information storing area 83, as indicated in the example of profile storing data shown in FIG. 5. Further, for instance, the indispensable condition information, such as “PUNCH=ON”, etc., is stored into the indispensability condition information storing area 85. Still further, the contact address information (IP address and E-mail address) of the terminal device 11, established from the contact address screen 40b, is stored into the contact address information storing area 86. Still further, the setting information, such as “1” (ON=1 or OFF=0), etc., is stored into the display selection setting information storing area 87. Yet further, when the number of pages to be printed in the print job concerned is 15 pages, the page number information, such as a numeral of “15”, etc., is stored into the page number information storing area 84.

### <Method for Calculating Processing Suitability Level>

Next, the method for calculating the processing suitability level will be detailed in the following. As aforementioned, in the present embodiment, the processing suitability level is calculated by regarding the printing velocity and the post processing as the calculating objects.

With respect to the post processing, the kinds of post processing to be applied in the print job concerned are compared with the kinds of post processing provided in the printer 10 concerned (own printer) in order to determine whether or not those coincide with each other, and then, the calculation is conducted by adding predetermined points corresponding to the result of the above-mentioned comparison to the processing suitability level. In the present embodiment, when determining that at least one of post processing, to be applied in the print job, coincides with any one of the kinds of post processing provided in the printer 10 concerned, “10 points×number of coinciding post processing” is added to the processing suitability level, while, when determining that none of post processing, to be applied in the print job, coincide with the kinds of post processing provided in the printer 10 concerned, “0 point” is added to the processing suitability level.

For instance, when three kinds of post processing are selectable in the setting operation of the print job, those three kinds of post processing are selected and all of them coincide with the post processing provided in the printer concerned (own printer), 30 points are added to the processing suitability level. When only two of them coincide with the post processing provided in the printer concerned, 20 points are added to the processing suitability level. When only one of them coincides with the post processing provided in the printer concerned, 10 points are added to the processing suitability level. When a single kind of post processing is selected and coincides with the post processing provided in the printer concerned, 10 points are added to the processing suitability level. Either when none of them coincide with the post processing provided in the printer concerned, or when none of post processing is selected in the setting operation of the print job, 0 point is added to the processing suitability level.

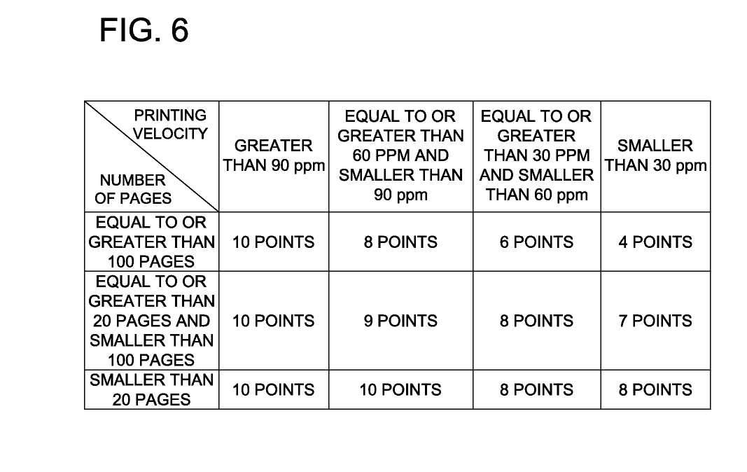

With respect to the printing velocity, the calculation is conducted by adding predetermined points, which are established in advance from the number of pages in the print job concerned and the printing velocity of the printer 10 concerned (own printer), to the processing suitability level. FIG. 6 shows a table indicating examples of the addition points in regard to the printing velocity.

As shown in FIG. 6, the number of pages is established at three stages, including “fewer than 20 pages”, “equal to or more than 20 pages and fewer than 100 pages” and “equal to or more than 100 pages”, while the printing velocity (ppm; page per minutute) is established at four stages, including “lower than 30 ppm”, “equal to or higher than 30 ppm and lower than 60 ppm”, “equal to or more than 60 ppm and lower than 90 ppm” and “equal to or higher than 90 ppm”, so as to respectively allot the predetermined points (4, 6-10 points) to the abovementioned (3×4=12) combinations.

In the present embodiment, on the premise that the higher the printing velocity is, the easier for the printer to suit the print job becomes, and the more the number of pages is, the more difficult for the printer to suit the print job becomes, the 10 points, serving as the highest points, is established for the combinations with the fastest printing velocity (“equal to or higher than 90 ppm” versus each of the numbers of pages), and, the numbers of points are established in such a manner that, according as the printing velocity of the current combination shifts from a high printing velocity to a low printing velocity, the established points shift from a large number of points to a small number of points, and further, in such a manner that, according as the number of pages increases, the difference between the points of the combination having a high printing velocity and that having a low printing velocity becomes great (point difference; the combination having a high printing velocity>the combination having a low printing velocity). According to the point setting method mentioned in the above, any one of 4, 6-10 points is added to the processing suitability level, corresponding to the combination of the number of pages in the print job concerned and the printing velocity of the printer 10.

The method of calculating the processing suitability level has been exemplified in the foregoing.

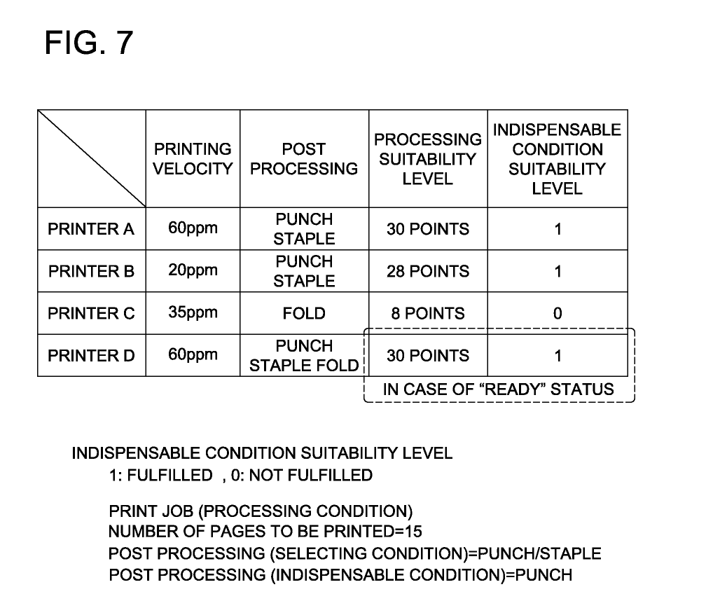

FIG. 7 shows a table indicating the exemplified printing velocities of the four printers 10a, 10b, 10c and 10d (respectively corresponding to PRINTER A, PRINTER B, PRINTER C and PRINTER D), the exemplified kinds of post processing being applicable by each of the four printers, and the processing suitability levels and the indispensable condition suitability levels, both corresponding to the exemplified profile (processing conditions) shown in FIG. 5. According to the processing suitability level calculating method mentioned in the above, the processing suitability levels of the four printers 10a, 10b, 10c and 10d are calculated at 30 points, 28 points, 8 points and 30 points, respectively. Further, the indispensable condition suitability levels of the four printers 10a, 10b, 10c and 10d are determined as 1 (fulfilled), 1 (fulfilled), 0 (not fulfilled) and 1 (fulfilled), respectively.

As shown in FIG. 5, the processing suitability levels and the indispensable condition suitability levels are stored into the suitability information storing areas 82 of the profile 80, separately for each of the printers.

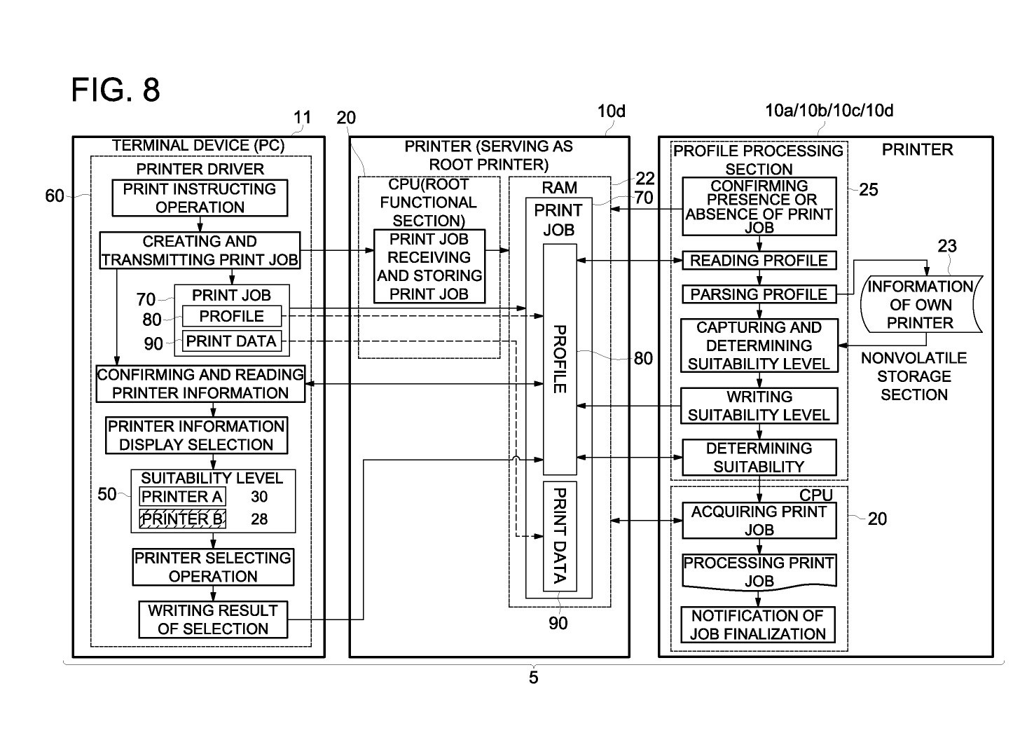

FIG. 8 shows a functional block diagram indicating functions of software (programs) installed in each of the printers coupled to the printing system 5.

A printer driver 60 of the terminal device 11 is provided with various kinds of operational functions including: a print instruction operating function for accepting the settings in regard to the printing operation (processing conditions, a contact address, a printer information display selection) and the print instructing operations, through the printer driver function selection screen 40 and another function selecting screen (such as a print job setting screen, etc.), which are displayed on the display section of the terminal device 11; a print job creating and transmitting function for receiving the print instruction to create a print job 70 (print data 90 and the profile 80) so as to transmit the created print job 70 to the printer 10d serving as the root printer; a printer information confirming and reading function for accessing the profile 80 stored in the predetermined storage area provided within the RAM 22 of the printer 10d, in respect to the print job 70 whose printer information display selection is set at the “presence” (ON), so as to confirm that the printer has surely written the processing suitability level into the profile 80, and then, reading the information (the printer information and the suitability level), in regard to the printer into which the suitability level has been written, from the profile 80, in order to display the information onto the display section of the terminal device 11; a printer selection screen displaying function for displaying a printer selection screen 50 onto the display section of the terminal device 11 by using the information read in the above; a printer selection and operating function for accepting operations (user's operations) for selecting a printer, which will serve as a destination printer that implements the print job 70, through the printer selection screen 50; and a selection result writing function for writing the selection result into the profile 80 of the printer 10d.

The root functional section of the CPU 20 in the printer 10d serving as the root printer is provided with a print job receiving and storing function for storing the print job 70 (including the profile 80 and the print data 90), received from the terminal device 11 through the network interface section 29, into a predetermined storage are within the RAM 22.

The profile processing section 25 of each of the four printers 10a, 10b, 10c and 10d is provided with: a print job presence or absence confirming function for accessing the predetermined storage area provided in the RAM 22 of the printer 10d serving as the root printer, so as to confirm the presence or absence of the print job 70 to be stored therein; a profile reading function for reading the profile 80 stored in the predetermined storage area; a profile parsing function for parsing the profile 80 read in the above; functions (a processing suitability level calculating function and an indispensable condition suitability level determining function) for calculating and determining the suitability level, based on the information (the printing velocity and the kinds of post processing) of the concerned printer (own printer), which is read from the nonvolatile storage section 23, and the parsed profile; a writing function for writing the suitability level and the printer identifying ID, included in the information of the concerned printer (own printer), into the profile 80 (suitability information storing area 82 in the profile 80) provided in the printer 10d; and a suitability determining function for determining the suitability of the concerned printer (own printer) for the print job 70, based on the suitability level stored in the profile 80, so as to determine whether or not the print job 70 should be implemented.

The CPU 20 of each of the four printers 10a, 10b, 10c and 10d is provided with: a print job acquiring function for acquiring the print job 70 from the predetermined storage area provided in the RAM 22 of the printer 10d serving as the root printer; a job processing function for controlling the printing section 27, based on the print data 90 included in the print job 70, so as to implement the print processing, and controlling the post processing section 28 so as to implement the post processing; and a job finalization notifying function for notifying the terminal device 11 of the finalization of the print job concerned, through the network interface section 29.

Further, when accessing the profile 80 provided in the printer 10d, the printer 10 (any one of the four printers 10a, 10b, 10c and 10d) or the terminal device 11 sends a accessing request (reading request or writing request) to the printer 10d so as to access the profile 80 concerned, through the root functional section (CPU 20) provided in the printer 10d. In other words, when receiving the request for accessing the profile 80, the root functional section of the printer 10d actually conducts the reading and writing operations.

Next, the operations to be conducted in the root functional section provided in the printer 10d serving as the root printer, the terminal devices 11 and the four printers 10a, 10b, 10c and 10d, which constitute the printing system 5, will be detailed in the following.

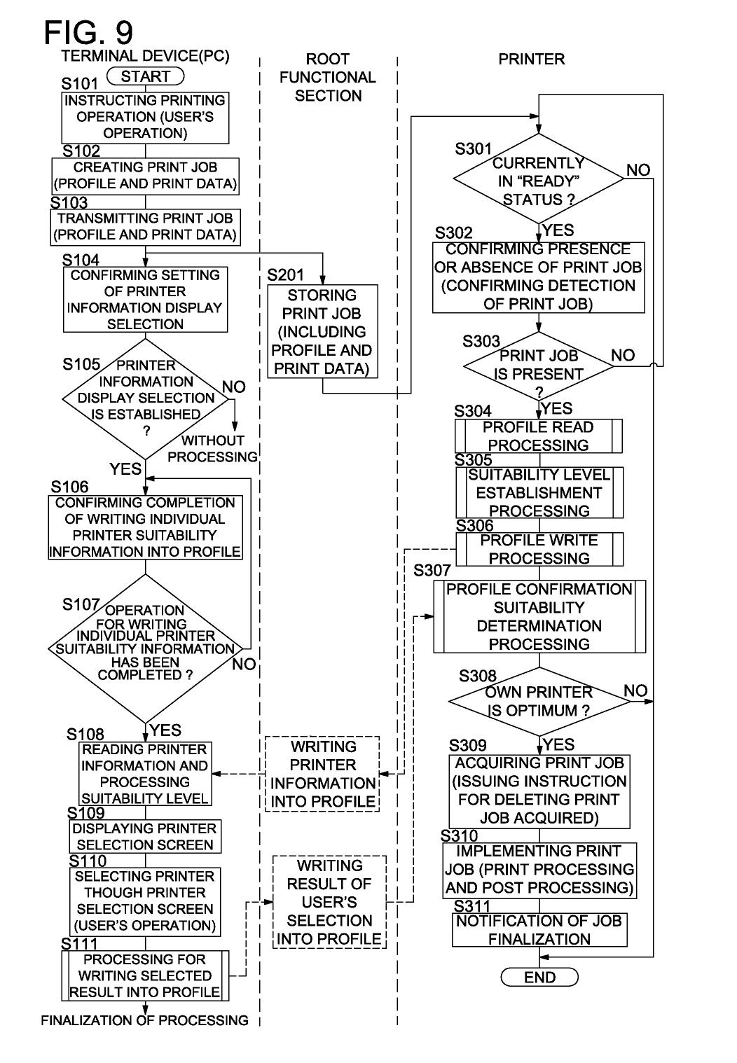

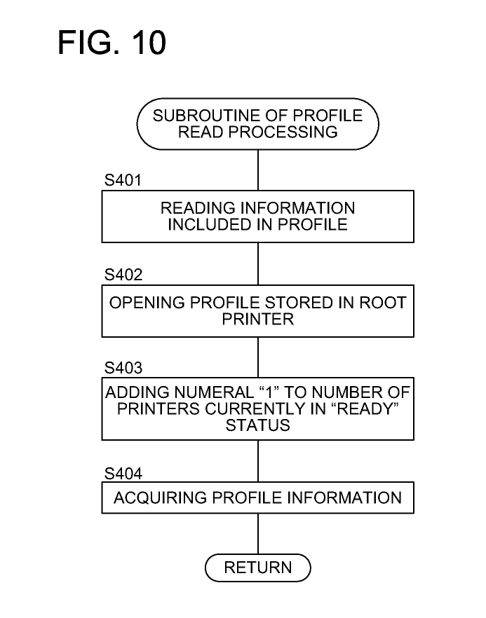

FIG. 9 shows a flowchart indicating flows of operations to be conducted by the abovementioned apparatuses constituting the printing system 5, embodied in the present invention. FIG. 10 through FIG. 14 show flowcharts and a schematic diagram, indicating detailed processing operations (such as a subroutine and a printer selection screen) of the operations indicated in the flowchart shown in FIG. 9. Herein, referring to FIGS. 10 through 14, the operations to be conducted by each of the abovementioned apparatuses constituting the printing system 5 (operations to be conducted in the whole system) will be detailed. Further, referring to FIG. 9, the operational flow, including the operations to be conducted from the time when a print job is introduced into the system from the terminal device 11 and has stored into the printer 10d serving as the root printer, to the time when the print job has been processed by any one of the four printers 10a, 10b, 10c and 10d, which serves as the processing destination site of the print job concerned, will be detailed in the following.

Receiving the operation for instructing the printing operation conducted by the user (Step S101), the printer driver 60, provided in the terminal device 11, creates the profile 80 and the print data 90, so as to create the print job 70 including them (Step S102). Then, the printer driver 60 stores various kinds of information, including the post processing information, the page number information of the print job concerned, the indispensability condition information, the contact address information of the terminal device 11 and the setting information of the printer information display selection, into the post processing information storing area 83, the page number information storing area 84, the indispensability condition information storing area 85, the contact address information storing area 86 and the display selection setting information storing area 87, which are provided in the profile 80, respectively, as aforementioned referring to FIG. 5. Further, the printer driver 60 stores numeral “0” into the printer number information storing area 81 as the initial value of the number of printers currently in the “Ready” status. Still further, the printer driver 60 transmits the print job 70 to the printer 10d serving as the root printer (Step S103).

Receiving the print job 70 transmitted from the terminal device 11, the root functional section of the CPU 20, provided in the printer 10d (root printer), stores the print job 70 (including the profile 80 and the print data 90) into the predetermined storage area of the RAM 22 (Step S201).

At the time of “Ready” status (Step S301; Yes), the profile processing section 25 of each of the four printers 10a, 10b, 10c and 10d periodically accesses the predetermined storage area of the RAM 22, provided in the printer 10d, so as to confirm the presence or absence of the print job 70 (Step S302).

When determining that the print job 70 is absent (Step S303; No), the profile processing section 25 returns to Step S301 so as to repeat the operations for periodically accessing the predetermined storage area at the time of “Ready” status and confirming the presence or absence of the print job 70 (Step S301; Yes→Step S302→Step S303). When determining that the current status is not “Ready” (Step S301; No), the profile processing section 25 finalizes the operation without accessing the predetermined storage area (END). Returning to the “Ready” status, the profile processing section 25 resumes the periodical accessing operation and the operation for confirming the presence or absence of the print job 70.

The accessing periods of all of the four printers 10a, 10b, 10c and 10d are the same as each other. Accordingly, when plural printers among them are currently in the “Ready” status, within the time interval shorter than a single accessing period after the first one of the plural printers has conducted the accessing operation, all of the other printers conduct the accessing operation. For instance, when the accessing operation is conducted for every 0.5 sec. (accessing period=0.5 sec.), within the time interval shorter than 0.5 sec. after the first one of the plural printers has conducted the accessing operation, all of the other printers conduct the accessing operation.

Successively, when determining that the print job 70 is present (Step S303; Yes), the profile processing section 25 sequentially conducts the profile read processing (Step S304), the suitability level establishment processing (Step S305) and the profile write processing (Step S306) one by one.

FIG. 10 shows a flowchart indicating a subroutine of the profile read processing to be conducted by the profile processing section 25 of each of the four printers 10a, 10b, 10c and 10d. When starting the subroutine concerned, the profile processing section 25 reads the information included in the profile 80 of the print job 70 detected (Step S401). Herein, the profile processing section 25 reads the post processing information, the page number information and the indispensable condition information, which are shown in FIG. 5.

Successively, the profile processing section 25 opens the profile 80 stored in the printer 10d (Step S402) so as to add numeral “1” to the value (initial value=0) of the number of printers currently in the “Ready” status, which is stored in the printer number information storing area 81, and then, closes the profile 80 (Step S403). The number of printers currently in the “Ready” status, acquired by the abovementioned adding operation, indicates the number of printers that have detected the print job 70 and have read the information included in the profile 80. Further, in the printer that has conducted the adding operation, the value of number of printers, acquired by the abovementioned adding operation, indicates the order of detecting the print job 70 and reading the information included in the profile 80 (order of commencing the profile read processing in regard to the print job 70). The writing position is determined by using the abovementioned order, when the individual printer suitability information is to be written into any one of the suitability information storing areas 82. In the present embodiment, the area numbers represented by “address 1” through “address N” are allotted to the plurality of suitability information storing areas 82 in order of “1” to “N”, and the writing position is determined by the Equation of “reading order of profile 80=area number”.

The profile processing section 25 stores the number of printers currently in the “Ready” status, acquired by the abovementioned adding operation, (=“reading order of profile 80”=“area number of suitability information storing area 82 into which individual printer suitability information is to be written”) and retains it within the printer 10 concerned. Further, the profile processing section 25 acquires the post processing information, the page number information and the indispensable condition information, which are to be employed for the suitability determining operation (determining whether or not the print job should be implemented), from the information included in the profile 80 read in the Step S401 (Step S404), and finalizes the subroutine concerned (Return).

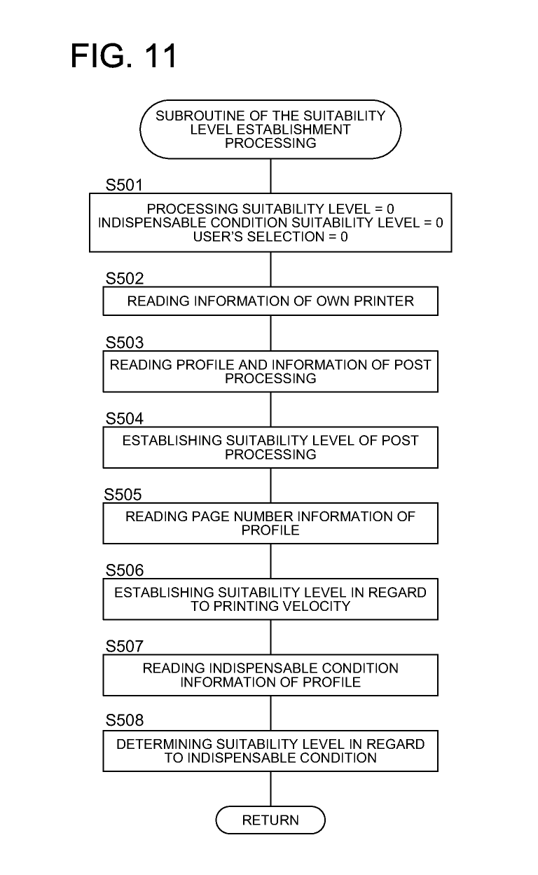

FIG. 11 shows a flowchart indicating a subroutine of the suitability level establishment processing to be conducted by the profile processing section 25 of each of the four printers 10a, 10b, 10c and 10d. Commencing the subroutine abovementioned, the profile processing section 25 clears the values of the individual printer suitability information to be written into the profile 80 to Zero. Concretely speaking, in order to write the individual printer suitability information into the profile 80, the profile processing section 25 writes numeral “0” (setting value=0) into each of the storage areas for storing the processing suitability level, the indispensable condition suitability level and the user's selection, which are retained in the RAM 22 of the printer 10 concerned (Step S501).

Successively, as the own printer information to be utilized for the suitability determining operation for the print job concerned, the profile processing section 25 reads the printing velocity and the kinds of corresponding post processing from the nonvolatile storage section 23 (Step S502), so as to establish the suitability level.

At first, based on the post processing information of the own printer and the other post processing information of the profile acquired in Step S404 shown in FIG. 10 (Step S503), the profile processing section 25 calculates and establishes the suitability level (Step S504). The above-mentioned establishing operation is conducted by adding the calculated value (points) of the suitability level, in regard to the post processing, to the setting value stored in the processing suitability level storing area provided in the RAM 22 (“processing suitability level”=“suitability level of post processing”).

Still successively, based on the printing velocity of the own printer and the page number information of the profile acquired in Step S404 shown in FIG. 10 (Step S505), the profile processing section 25 calculates and establishes the suitability level in regard to the printing velocity (Step S506). The abovementioned establishing operation is conducted by adding the calculated value (points) of the suitability level, in regard to the printing velocity, to the setting value stored in the processing suitability level storing area provided in the RAM 22 (“processing suitability level”=“suitability level of post processing”+“suitability level of printing velocity”).

Yet successively, based on the post processing of the own printer and the indispensable condition information acquired in advance in Step S404 shown in FIG. 10 (Step S507), the profile processing section 25 determines and establishes the suitability level in regard to the indispensable condition (Step S508). The abovementioned establishing operation is achieved by writing numeral “1” into the indispensable condition suitability level storing area provided in the RAM 22, only when the post processing of the own printer is in conformity with the indispensable condition (“indispensable condition level”=“1” when being in conformity with the indispensable condition, while, “indispensable condition level”=“0” when being not in conformity with the indispensable condition).

When completing the operations for establishing the abovementioned suitability levels, the profile processing section 25 finalizes the subroutine concerned (Return).

FIG. 11 shows a flowchart indicating a subroutine of the profile write processing to be conducted by the profile processing section 25 of each of the four printers 10a, 10b, 10c and 10d. Commencing the subroutine abovementioned, at the timing when the one period of the periodical accessing operation has elapsed after the profile 80 has been read (for instance, at the timing when 0.5 sec. has elapsed after the print job 70 was detected), the profile processing section 25 opens the profile 80 provided in the printer 10d serving as the root printer (Step S601), so as to respectively write the individual printer suitability information into the suitability information storing areas 82 to which the area numbers same as the number of retaining printers, currently in the “Ready” status, are allotted (Step S602). For instance, when the number of retaining printers, being currently in the “Ready” status, is “1”, the profile processing section 25 writes the individual printer suitability information into the suitability information storing area 82 of the area number “1” (address 1). In this example, the profile processing section 25 writes the printer identifying ID of the own printer, the printer information (such as a name of printer, a printing velocity, a kind of corresponding post processing, etc.) of the own printer, the processing suitability level and the indispensable condition suitability level, both established in the suitability level establishment processing aforementioned. After that, the profile processing section 25 closes the profile 80 and finalizes the subroutine concerned (Return).

As aforementioned, since the periodical accessing periods of all of the four printers 10a, 10b, 10c and 10d are the same as each other, when plural printers among them are currently in the “Ready” status, within the time interval shorter than a single accessing period after the first one of the plural printers has conducted the accessing operation, all of the other printers, which are currently in the “Ready” status, access the profile 80. Further, in this case, when the first one of the plural printers writes the individual printer suitability information at the time when a single accessing period has elapsed after accessing the profile 80 concerned, the number of individual printer suitability information written into the profile 80 (“1” in this case) does not coincide with the number of printers currently in the “Ready” status, stored in the printer number information storing area 81, but the number of printers is larger than the number of individual printer suitability information (number of individual printer suitability information<number of printers currently in “Ready” status). Both of them coincide with each other at the time when the final one of the printers currently in the “Ready” status, which finally accesses the profile 80, completes the operation for writing the individual printer suitability information. In other words, after the number of the printers currently in the “Ready” status has been rewritten to “1” from the “initial value=0”, all of the printers currently in the “Ready” status complete the operation for writing the individual printer suitability information into the profile 80 at the time when the number of the printers currently in the “Ready” status coincides with the number of individual printer suitability information.

Further, even if anther printer returns to the “Ready” status before arriving at the abovementioned write completion timing, it is also possible for the printer concerned to access the profile 80 and to write the individual printer suitability information into the profile 80. For instance, in such a case that anther printer newly enters into the “Ready” status during the time interval from the time when the final one of the printers currently in the “Ready” status finally accesses the profile 80 to the time when the final one completes the operation for writing the individual printer suitability information into the profile 80, the write completion timing is reestablished at the timing when the concerned printer, which has newly entered into the “Ready” status, completes the operation for writing the individual printer suitability information into the profile 80.

Retuning to the flowchart shown in FIG. 9, the printer driver 60 of the terminal device 11 confirms the setting of the printer information display selection of the print job 70 instructed by the user (Step S104). When determining that the printer information display selection is not established (Step S105; No), the printer driver 60 finalizes the operation for processing the print job 70 (without processing). On the other hand, when determining that the printer information display selection is established (Step S105; Yes), the printer driver 60 accesses the profile 80 provided in the printer 10d serving as the root printer, so as to confirm whether or not the operation for writing the individual printer suitability information has been completed (Step S106).

The abovementioned confirming operation is achieved by monitoring whether or not the number of printers currently in “Ready” status and the number of individual printer suitability information (equal to or more than “1”), written in the profile 80, coincide with each other. When determining that both of them do not coincide with each other, the printer driver 60 determines that the writing operation is not completed (Step S107; No), and continues the confirming operation in Step S106. When determining that both of them coincide with each other, the printer driver 60 determines that the writing operation is completed (Step S107; Yes), and then, reads the printer information and the processing suitability level, in regard to the printer whose suitability level, included in the individual printer suitability information, reaches to the predetermined level, from the profile 80 (Step S108).

In the present embodiment, the printer whose indispensable condition suitability level is equal to “1” (indispensable condition; suitable) is made to be a reading object. In this connection, in addition to the above, it is also applicable that only such a printer whose processing suitability level reaches the predetermined level is made to be a reading object. Further, it is applicable that the predetermined level of the processing suitability level is set at, for instance, 20 points, as far as the aforementioned method for calculating the processing suitability level is employed. In this case, even if the indispensable condition is suitable, the printer whose processing suitability level is smaller than 20 points will be excluded from the reading object.

The printer information to be read includes a name of printer, a printing velocity and kinds of corresponding post processing. With respect to the post processing, it is applicable that, when the indispensable condition is established, only the kind of post processing, which is in conformity with the indispensable condition concerned, is read.

For instance, when the three printers 10a, 10b and 10c, other than the printer 10d serving as the root printer, are currently in the “Ready” status, the individual printer suitability information sets (excluding the user's selection result), respectively corresponding to the three printers 10a, 10b and 10e, exemplified in FIG. 5, are written into the profile 80. On that occasion, the printer driver 60 reads the printer information and the processing suitability level of each of the printers 10a (PRINTER A) and 10b (PRINTER B), whose indispensable condition suitability level is set at “1”.

Successively, the printer driver 60 displays the printer information and the processing suitability level, read from the profile 80, onto the printer selection screen 50 (Step S109).

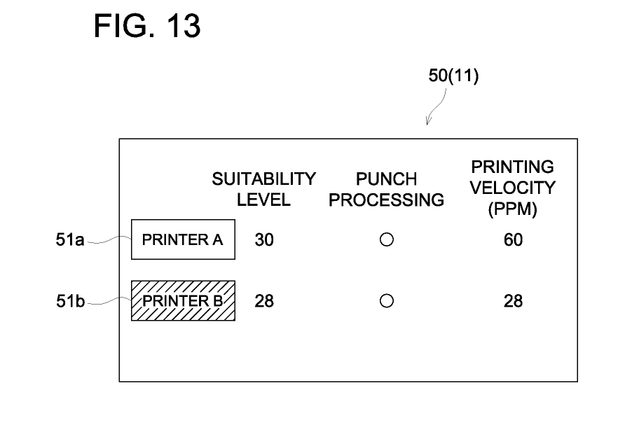

FIG. 13 shows a schematic diagram indicating an example of the printer selection screen 50. Onto the printer selection screen 50, a printer name 51 (51a, 51b), the post processing, the printing velocity and the processing suitability level of the printer concerned are displayed for every printer. The printer names 51a and 51b are displayed as soft buttons so as to make it possible to accept the user's clicking operation for conducting changeover between the selection and the non-selection. With respect to the post processing, only the punch processing, established as, for instance, the indispensable condition, is displayed in this example.

In the printer selection screen 50 shown in FIG. 50, displayed are the printer information and the processing suitability levels of both the printers 10a (PRINTER A) and 10b (PRINTER B). With respect to the processing suitability level, its value (points) of the printer 10a is larger than that of the printer 10b.

It is possible for the user to select a specific printer, which will serve as the processing destination site of the print job 70, through the printer selection screen 50. For instance, when the printer 10b is located at such a position that is nearer to the user's desk than that of the printer 10a (refer to FIG. 1), and when the user confirms the printing velocity of printer 10b whose processing suitability level is relatively low, and then, determines that the printing velocity of printer 10b is allowable for outputting the number of pages included in the print job 70, it is possible for the user to select the printer 10b, to which the concerned user can easily access in order to take out the outputted printouts, as the processing destination site of the print job 70. In order to select the printer 10b, the user clicks the printer name 51b (PRINTER B) displayed on the printer selection screen 50 so as to change the screen to the selecting status, and conducts the fixing operation.

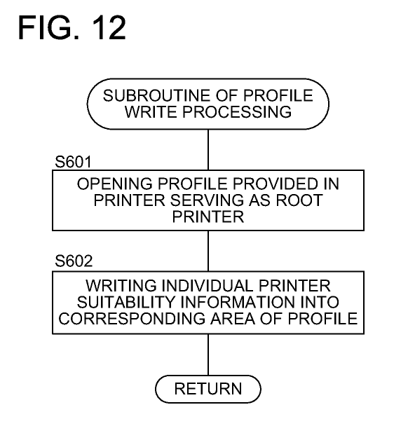

Returning to the flowchart shown in FIG. 9, when receiving the fixed result of selecting the printer though the printer selection screen 50 (Step S110), the printer driver 60 conducts the profile write processing for writing the selected result into the profile 80 provided in the printer 10d (Step S111). The abovementioned processing will be detailed in the following by referring to the subroutine of the profile write processing shown in FIG. 12.

Commencing the profile write processing, the printer driver 60 opens the profile 80 provided in the printer 10d serving as the root printer (Step S601) so as to retrieve the individual printer suitability information corresponding to the printer information in which the printer name coinciding with that of the selected printer is included, and then, rewrites the value of the user's selection result from “0” to “1”, in the individual printer suitability information of the printer concerned (Step S602). Then, the printer driver 60 closes the profile 80 and finalizes the subroutine of the profile write processing (Return). Successively, finalizing the profile write processing as abovementioned, the printer driver 60 also finalizes the processing in regard to the print job 70 concerned (END OF PROCESSING).

For instance, when the user selects the printer 10b, the printer driver 60 retrieves the individual printer suitability information corresponding to the printer information in which the printer name of the printer 10b is included (individual printer suitability information of printer 10b), and then, rewrites the value of the user's selection result from “0” to “1” (refer to FIG. 5).

At the time when a predetermined time has elapsed after completing the profile write processing (Step S306), the profile processing section 25 of each of the four printers 10a, 10b, 10c and 10d conducts the profile confirmation suitability determination processing (Step S307). The predetermined time is set at, for instance, a single cycle of the periodical accessing time interval (for instance, 0.5 sec.) or another time interval slightly longer than the above (for instance, 1.0 sec.), etc.

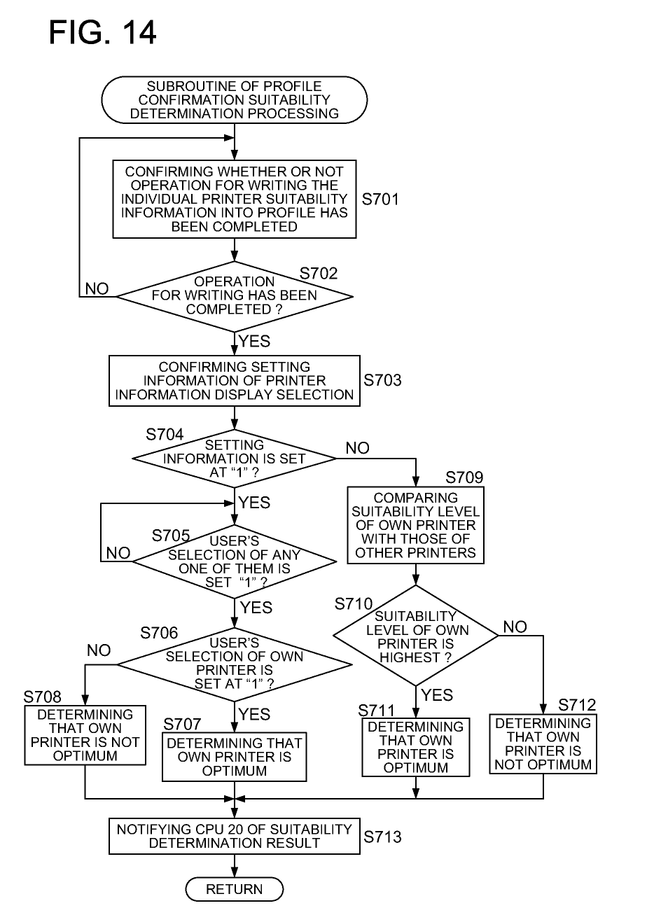

FIG. 14 shows a flowchart indicating a subroutine of the profile confirmation suitability determination processing to be conducted by the profile processing section 25 of each of the four printers 10a, 10b, 10c and 10d. Commencing the operation of the subroutine concerned, the profile processing section 25 accesses the profile 80 provided in the printer 10d serving as the root printer, so as to confirm whether or not the operation for writing the individual printer suitability information has been completed (Step S701).

The abovementioned confirming operation is achieved by monitoring whether or not the number of printers currently in the “Ready” status, which is stored in advance in the profile 80, coincides with the number of individual printer suitability information sets, which are currently written into the profile 80. When determining that both of them do not coincide with each other, the profile processing section 25 determines that the operation for writing the individual printer suitability information has not been completed (Step S702; No), and continues the confirming operation in Step S701. When determining that both of them coincide with each other, the profile processing section 25 determines that the operation for writing the individual printer suitability information has been completed (Step S702; Yes), and then, confirms the setting information of the printer information display selection stored in the display selection setting information storing area 87 provided in the profile 80 (Step S703).

When determining that the setting information is set at “1” (presence of establishment) (Step S704; Yes), the profile processing section 25 further confirms the user's selection results for all of the individual printer suitability information sets stored in the profile 80, in order to determine whether or not numeral “1” is set in any one of them (Step S705).

When determining that all of the user's selection results are “0” and numeral “1” is set in none of them (Step S705; No), since the current status is determined as such a state that the printer selecting operation conducted by the user has not been completed, the profile processing section 25 continues the abovementioned confirming operation. When determining that numeral “1” is set in any one of them (Step S705; Yes), since the current status is determined as such a state that the printer selecting operation conducted by the user has been completed, the profile processing section 25 further confirms whether or not the user's selection result of the own printer is set at “1” (Step S706). In other words, the profile processing section 25 confirms whether or not the user has selected the own printer. This confirming operation is achieved by confirming the printer identifying ID stored in the individual printer suitability information of the printer for which the user's selection result is set at “1”, and further confirming whether or not the printer identifying ID above-confirmed coincides with that of the own printer.

When determining that the user's selection result of the own printer is set at “1” (Step S706: Yes), the profile processing section 25 determines that the own printer is the optimum (Step S707), and notify the CPU 20 of the above-determined result (suitability determination result: own printer=optimum) (Step S713), and finalizes the subroutine concerned (Return). While, when determining that the user's selection result of the own printer is set at “0” (Step S706: No), the profile processing section 25 determines that the own printer is not optimum (Step S708), and notify the CPU 20 of the above-determined result (suitability determination result: own printer=non-optimum) (Step S713), and finalizes the subroutine concerned (Return).

When determining that the setting information of the printer information display selection is set at “0” (absence of establishment) (Step S704; No), the profile processing section 25 further confirms the processing suitability levels for all of the individual printer suitability information sets stored in the profile 80, in order to compare the processing suitability level of the own printer with those of the other printers (Step S709). When determining that the indispensable condition suitability level of the own printer is set at “1” (indispensable condition=suitable) and the processing suitability level of the own printer is the highest (Step S710; Yes), the profile processing section 25 determines that the own printer is the optimum (Step S711), and notify the CPU 20 of the above-determined result (suitability determination result: own printer=optimum) (Step S713), and finalizes the subroutine concerned (Return). While, when determining that the indispensable condition suitability level of the own printer is set at “0” (indispensable condition=unsuitable), or when determining that the processing suitability level of the own printer is not the highest (Step S710; No) even if the indispensable condition suitability level of the own printer is set at “1”, the profile processing section 25 determines that the own printer is not optimum (Step S711), and notify the CPU 20 of the above-determined result (suitability determination result: own printer=non-optimum) (Step S713), and finalizes the subroutine concerned (Return).

In this connection, when plural printers 10, whose indispensable condition suitability level are set at “1” and whose processing suitability level are the highest, exist in the system concerned, it is applicable that, for instance, a specific printer 10, which has detected the print job 70 at the earliest timing among the plural printers 10 concerned, is determined as the optimum. Alternatively, in the above case, it is also applicable that the profile processing section 25 compares the area number of the suitability information storing area 82, into which the individual printer suitability information of the own printer (indispensable condition suitability level: “1” and processing suitability level: optimum) has been written, with the area numbers of the other suitability information storing areas 82 into which the individual printer suitability information of the other printers (indispensable condition suitability level: “1” and processing suitability level: optimum) have been written, so as to determine that the own printer is the optimum when determining that the area number of the own printer is the smallest, while, to determine that the own printer is not optimum when determining that the area number of the own printer is not the smallest, or the like.

In the flowchart shown in FIG. 9, when receiving the notification sent from the profile processing section 25 indicating that the own printer is not optimum (Step S308; No), the CPU 20 of concerned one of the four printers 10a, 10b, 10c and 10d finalizes the operation of the flowchart without processing the print job 70 concerned (END). When receiving the notification sent from the profile processing section 25 indicating that the own printer is the optimum (Step S308; Yes), the CPU 20 acquires the print job 70 stored in the RAM 22 provided in the printer 10d serving as the root printer, so as to issue an instruction for deleting the print job 70 concerned (Step S309). According to this deleting instruction, the print job 70 is deleted from the RAM 22 provided in the printer 10d serving as the root printer.

In this connection, since the timings at which the plural printers 10 respectively conduct the profile confirmation suitability determination processing (Step S307) are different from each other, there possibly occurs such a case that, after a specific printer 10, which commenced the concerned processing at an earlier occasion and determined that the own printing was the optimum, has acquired the print job 70 and has deleted it from the printer 10d serving as the root printer, a certain residual printer 10 commences the concerned processing. In that case, since it is impossible for the profile processing section 25 of the certain residual printer 10 to access the profile 80, the profile processing section 25 concerned determines that the own printer (namely, certain residual printer 10) is not optimum, and then, notifies the CPU 20 of the above-determined result (suitability determination result: own printer non-optimum).

The CPU 20 of the specific printer 10, which has acquired the print job 70, implements the print job 70 concerned (Step S310). Completing the processing operations for the print job 70, the CPU 20 notifies the terminal device 11 of the finalization of the print job 70 (Step S311), and then, finalizes the operations of the flowchart (END). The notification of the job finalization is achieved by transmitting the concerned information to the IP address of the terminal device 11, acquired by using the contact destination information of the terminal device 11, which is included in the profile 80 of the print job 70, or by transmitting an E-mail of the concerned information to the E-mail address of the terminal device 11. The contents of the notification information include a name of job, a name of the own printer, etc.

As described in the foregoing, according to the printing system 5 embodied in the present invention, it becomes possible that the print job sent from the terminal device 11 is once stored into the predetermined printer 10 (in the present embodiment, corresponding to the printer 10d established as the root printer), and then, each of the plural printers (in the present embodiment, corresponding to the four printers 10a, 10b, 10c and 10d) parses the information (profile) of the print job stored into the predetermined printer 10, and the specific printer, whose suitability degree (suitability level) for the print job concerned is the highest among those of the other printers 10, acquires and processes the print job concerned by itself. Accordingly, it becomes possible to configure such the printing system in which any one of the plural printers 10 processes the print job sent from the terminal device 11, without employing an exclusive server that controls the plural printers 10 and manages the print job 70 sent from the terminal device 11 so as to determine the processing destination of the print job 70 concerned, and without employing an exclusive control program to be installed into the exclusive server or another server.

Accordingly, at the time of newly configuring the printing system embodied in the present invention, the cost for introducing the abovementioned exclusive server, the exclusive control program, etc., can be drastically suppressed to zero. In addition to the above, since no maintenance cost would be generated, it also becomes possible to make the system management operation easier than ever. For instance, even when a new printer is added to the system or the current printer (except the printer serving as the root printer) is removed from the system, it becomes possible to omit the management man-hours, since various kinds of operations for conducting setting changes of the printer management information, etc., become unnecessary.

Specifically in the present embodiment, since even the printer 10d, which is established as the root printer having a role for temporarily storing the print job sent from the terminal device 11, is provided with no specific function, other than the function for storing the print job concerned (function to be provided as the root functional section), it is not necessary to install a certain specific control program, or the like. Accordingly, it also becomes possible to suppress the cost increase of the printer having the root function.

Further, the printing system, embodied in the present invention, is so constituted that the suitability level for the print job is calculated by finding a total sum of the points separately found in regard to the print processing (relationship between the number of pages and the printing velocity) and the post processing (kind of suitable post processing). Accordingly, it becomes possible to make the specific printer 10, which is totally suitable for the print processing and the post processing in regard to the print job concerned (in other words, whose suitability level is the highest), acquire and implement the print job concerned.

Each of the printers 10 conducts the accessing operation for detecting the presence or absence of the print job stored in the predetermined printer 10 at the time when a new print job is implementable (in other words, the current status of the printer is “Ready”). As abovementioned, since only such the printer that is ready to immediately implement the new print job conducts the accessing operation, it becomes possible to prevent or suppress an idling time for waiting the implementation of the print job. Accordingly, it becomes possible to heighten the processing efficiency of the print job concerned (speedy processing).

For instance, according to the conventional printing system, when the user designates a printer to be made to conduct the printing operation, although the user has intended to send the print job to a vacant printer, sometimes, there would occur such a case that the concerned user should wait for a longtime until the printout of the print job concerned is actually outputted from the printer designated by the user, due to the fact that other plural users have sent other print jobs to the same printer at the same timing. However, according to the printing system 5 embodied in the present invention, even if the plural users have sent the plural print jobs at the same timing, each of the printers, which is not currently operated, voluntarily accepts and implements each of the plural print jobs. Therefore, it becomes possible to securely and speedily conduct the printing operation.

Further, according to the present invention, even when the user does not designate the printer information display selection, it becomes possible to automatically output the printout from a specific printer 10, which is most suitable for the processing conditions instructed by the user among a plurality of printers 10. On the other hand, when the user designates the printer information display selection, since it is possible for the user to select the printout destination printer (serving as the processing destination site), while confirming information (such as the processing suitability level, the printing velocity, etc.) of the printer whose suitability level has reached to the predetermined level (namely, the concerned printer fulfills the predetermined condition, such as a fact that the indispensable condition suitability level is set at “1” (indispensable condition is suitable), or another fact that the processing suitability level has reached to the predetermined level, etc.) on the printer selection screen of the terminal device 11, it becomes possible for the user even to make the specific printer, located near the user's own desk, output the printout, as far as the level of the printing velocity, etc., are reasonable and no problem even if the suitability level is inferior to the other printers. In other words, since the user can employ the processing suitability level, the printing velocity, etc., as guideline for selecting the printout destination printer, it becomes easy for the user to determine the printout destination printer. Further, by displaying the information only in regard to the printer whose processing suitability level has reached to the predetermined level, it becomes easy for the user not only to confirm the contents of the display screen, but also to select the user's desired printer serving as the printout destination printer.

Still further, in the setting operation in regard to the post processing of the print job, the terminal device 11 (printer driver 60) can accept the operation for establishing the non-indispensable condition, which is to be conducted by the user (refer to FIG. 3). Accordingly, even when all of the printers, which have found the suitability level of the print job to which the selecting condition is established in advance, are not in conformity with the selecting condition, or the like, any one of the printers acquires the print job and implements the print job concerned, while omitting the selecting condition. According to this feature of the present embodiment, it becomes possible to avoid such a case that the print job is not implemented, or is entered into the implementation waiting status so as to make its implementation postpone to the later opportunity, unless the processing condition of the print job concerned is fulfilled, resulting in an improvement of the convenience aspect.

Yet further, since the instruction for deleting the print job is issued from the printer 10 that has acquired the same print job, the concerned print job is deleted from the printer 10d, which serves as the root printer, based on the instruction above-issued. Therefore, it becomes possible to make it easy to conduct a print job managing operation so that the processing of a single print job is not duplicated by the plural printers 10.

### Second Embodiment

In the foregoing, there has been detailed such the case that all of the processing operations in regard to the printer information display selection are conducted by the printer driver 60 installed in the terminal device 11, as the first embodiment. Successively, there will be detailed in the following such a case that a part of the abovementioned processing operations is conducted by the printer 10 serving as the root printer, as the second embodiment.

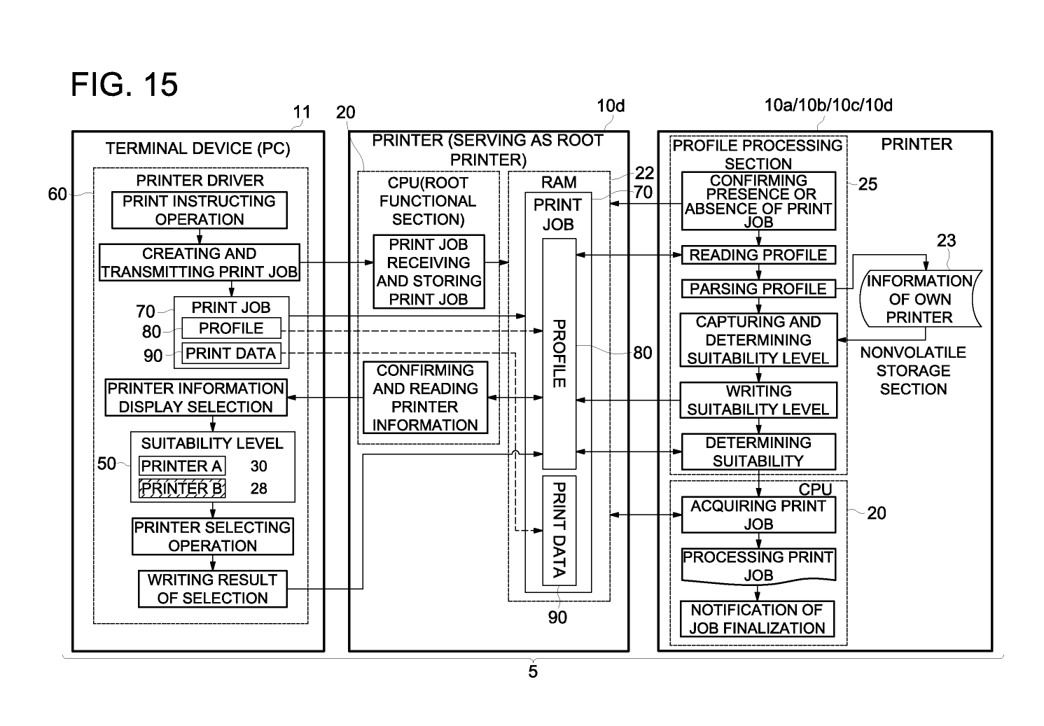

FIG. 15 shows a functional block diagram indicating functions of software (programs) installed in each of the printers coupled to the printing system 5, embodied in the present invention as the second embodiment. The different point between the first and second embodiments lays on the fact that the functions similar to the printer information confirming and reading functions, which are provided in the printer driver 60 of the first embodiment, are shifted into the root functional section of the CPU 20 provided in the printer 10d sewing as the root printer. Herein, only the functions being different from the first embodiment will be detailed in the following.

With respect to the print job 70 for which the printer information display selection is established at “presence” (ON), the root functional section of the second embodiment is provided with such the functions (printer information confirming and reading functions) for accessing the profile 80 stored in the predetermined storage area provided within the RAM 22 of the own printer, confirming that the printer has written the suitability level into the profile 80, reading the information (printer information and suitability level) in regard to the concerned printer, which has written the suitability level, from the profile 80, and transmitting the information to the terminal device 11 whose IP address is included in the contact destination information stored in the profile 80, namely, the terminal device 11 that serves as the sender of the print job 70.

Further, the printer selection screen displaying function provided in the printer driver 60 of the second embodiment is such a function that makes the display section display the printer selection screen 50 thereon, based on the information (printer information and suitability level) received from the printer 10d sewing as the root printer.

The functions other than the abovementioned functions are the same as those of the first embodiment.

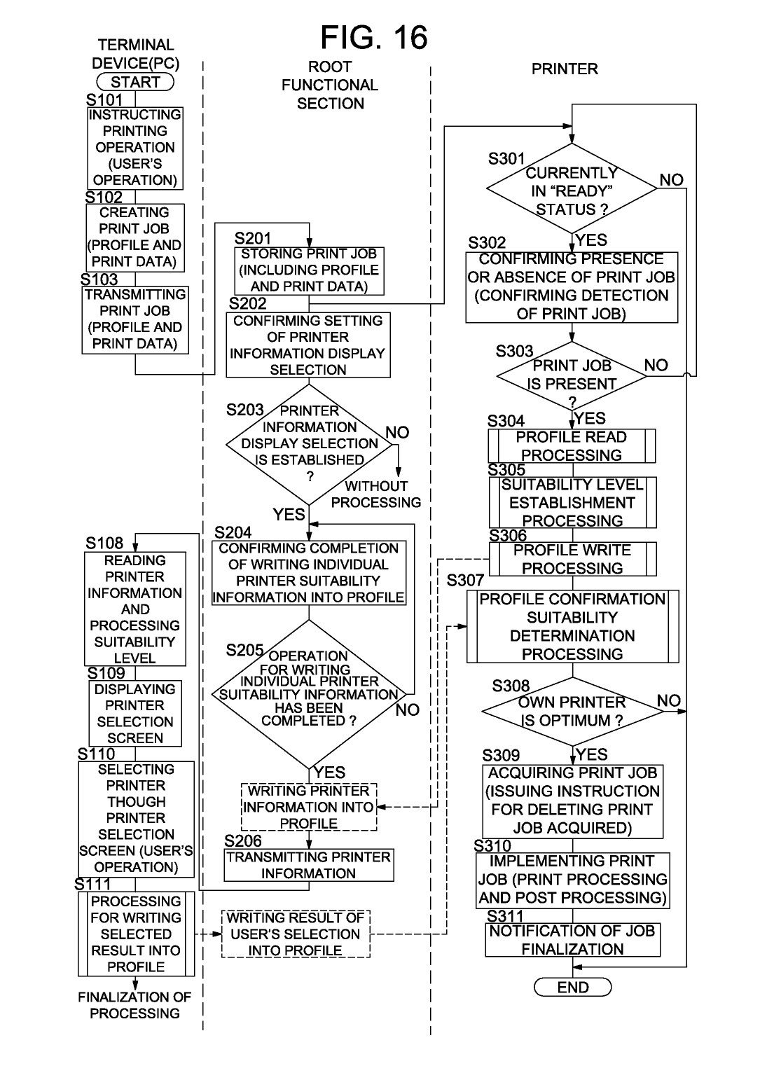

FIG. 16 shows a flowchart indicating flows of operations to be conducted by the apparatuses constituting the printing system 5, embodied in the present invention as the second embodiment. The different point between the first and second embodiments lays on the fact that the operations similar to those in Steps S104 through S108, which are to be conducted by the printer driver 60 of the terminal device 11 as indicated in the flowchart shown in FIG. 9, are shifted to the operations to be conducted by the root functional section of the CPU 20 provided in the printer 10d serving as the root printer. Herein, only the point being different from the first embodiment will be detailed in the following.

Storing the print job 70 (including profile 80 and print data 90) sent from the terminal device 11 into the predetermined storage area provided within the RAM 22 (Step S201), the root functional section of the CPU 20 provided in the printer 10d (serving as the root printer) confirms the setting information of the printer information display selection stored in the profile 80 (Step S202).

When determining that the value of the setting information is set at “0” (OFF) (Step S203; No), the root functional section finalizes the processing for the print job 70 concerned (WITHOUT PROCESSING). On the other hand, when determining that the value of the setting information is set at “1” (ON) (Step S203; Yes), the root functional section confirms whether or not the operation for writing the individual printer suitability information into the profile 80 has been completed (Step S204).

As well as the operation in Step S106 indicated in the flowchart of the first embodiment shown in FIG. 9, the abovementioned confirming operation is achieved by monitoring whether or not the number of printers currently in “Ready” status and the number of individual printer suitability information (equal to or more than “1”), written in the profile 80, coincide with each other. When determining that both of them do not coincide with each other, the root functional section determines that the writing operation is not completed (Step S205; No), and continues the confirming operation in Step S204. On the other hand, when determining that both of them coincide with each other, the root functional section determines that the writing operation is completed (Step S205; Yes), and then, reads the printer information and the processing suitability level, in regard to the printer whose suitability level, included in the individual printer suitability information, reaches to the predetermined level, from the profile 80, in order to transmit the printer information and the processing suitability level, above-read, to terminal device 11 (Step S206). In this connection, the reading and transmitting object (such that whose suitability level has reached to the predetermined level) and the printer information are the same as those described by referring to Step S108 shown in FIG. 9.

Successively, reading the printer information and the processing suitability level received from the printer 10d serving as the root printer (Step S108), the printer driver 60 of the terminal device 11 displays the printer information and the processing suitability level, concerned, onto the printer selection screen 50 (Step S109). After that, the printer driver 60 conducts the same operations as those of the first embodiment.

As described in the above, in the second embodiment, the printer 10 serving as the root printer (root functional section) conducts a part of the operations in regard to the printer information display selection. Accordingly, it becomes possible to simplify the configuration of the printer driver 60 to be installed into the terminal device 11, being simpler than that of the first embodiment.

Although the embodiments of the present invention have been described by referring to the drawings, the scope of the present invention is not limited to the embodiments described in the foregoing. Modifications and additions made by a skilled person without departing from the spirit and scope of the invention shall be included in the scope of the present invention.

Although, according to the aforementioned embodiments, the suitability degree (suitability level) of the print job is found so as to determine whether or not the concerned print job should be implemented, it is also applicable that the system is so constituted that, when the print job currently stored in the predetermined printer is detected, the concerned print job is acquired and implemented without conducting the abovementioned determining operation. For instance, when the functions provided in the plurality of printers constituting the printing system are the same as each other, the necessity for employing the suitability level to determine the suitable printer is relatively low. In this case, it is also applicable that the system is so constituted that a currently non-operated printer acquires and implements the print job as soon as the non-operated printer finds the concerned print job stored on the predetermined printer.

Further, it is also applicable that an absolute comparing method, in which the suitability level of the own printer is compared with the predetermined criteria, is employed for the suitability level comparing operation, instead of the relative comparing method in which the suitability level of the own printer is compared with those of the other printers. In this case, when the suitability level of the own printer is higher that the predetermined criteria, it is determined that the own printer should implements the print job, so as to acquires and implements the print job concerned.

Still further, it is also applicable that the operation for calculating the suitability level is conducted by employing factors other than the printing velocity and the post processing. Still further, although the printing system in the aforementioned embodiments is so constituted that the processing condition in regard to the post processing can be established as the selecting condition and the indispensable condition, it is also applicable that the printing system is so constituted that the processing condition in regard to the print processing can be established as the selecting condition and the indispensable condition. For instance, it may be applicable to make the various kinds of processing conditions, such as a print size (A4, A3, etc.), a one side or duplex printing, an integration printing (N-in-1 printing), a monochrome or color printing, etc., the objects of the selecting condition and the indispensable condition.

Still further, when a specific printer that is in conformity with the indispensable condition does not exist among the printers currently in the “Ready” status, which have detected the print job and have conducted the operations for parsing the profile and writing the suitability level, for instance, it is also applicable that the printer information (printer name, printing velocity, function of job processing, etc.) of the printer that has conducted the writing operation, and the suitability level (processing suitability level) are displayed on the terminal device 11, so as to accept the operation for selecting a specific printer serving as the processing destination site, which is to be conducted by the user.

Still further, the scope of the storage device that stores the print job sent from the terminal device 11, therein, is not limited to the RAM 22 provided in the printer 10 described while referring to the present embodiment. The other storage device, such as the nonvolatile storage section 23 and the HDD 24, both provided in the printer 10, is also applicable for this purpose. Further, the external storage device, for instance, such as the HDD (Hard Disc Drive) coupled to the network 2, the storage device provided in the server coupled to the network 2, etc., is also applicable for this purpose.

Still further, it is also applicable that the terminal device 11 (printer driver 60) is so constituted that it is possible to accept the user's operation (user's selecting operation) for selecting either an automatic mode, in which the processing destination site of the print job is automatically determined or the printer information display selection can be automatically designated, or a normal mode in which the user can designate the printer to be made to serve as the processing destination site (transmitting destination) of the print job concerned.

Yet further, the scope of the printer embodied in the present invention is not limited to the printers detailed in the present embodiment. It is needless to say that various kinds of other type printers, such as an MFP (Multi Function Peripheral) provided with the printer function, etc., are also applicable in the present invention.

According to the a printing apparatus and a printing system embodied in the present invention, it becomes possible to construct such a system configuration in which any one of a plurality of printers implements a print job outputted by a print instructing apparatus, without employing an exclusive apparatus that manages and controls the plurality of printers and the print job sent from the print instructing apparatus so as to determine a specific printer serving as the processing destination site of the print job concerned. Accordingly, it becomes possible not only to reduce the cost of the printing system, but also to make it easy to control the system operations.

While the preferred embodiments of the present invention have been described using specific term, such description is for illustrative purpose only, and it is to be understood that changes and variations may be invade without departing from the spirit and scope of the appended claims.

What is claimed is:

1. A printing apparatus serving as one of plural printing apparatuses, each of which acquires a print job stored in a storage device and is capable of implementing the print job, wherein the storage device stores the print job received from a print instructing apparatus, and receives accesses from the plural printing apparatuses, the printing apparatus comprising:
a detecting section to access to the storage device so as to detect the print job stored in the storage device;
an acquiring section to acquire the print job detected by the detecting section from the storage device; and
a processing section to implement the print job acquired by the acquiring section.

2. The printing apparatus of claim 1,
wherein the acquiring section determines whether or not the print job, detected by the detecting section, is to be implemented by the processing section.

3. The printing apparatus of claim 2,
wherein the acquiring section finds a suitability level in a case that the processing section implements the print job detected by the detecting section, so as to employ the suitability level for determining whether or not the print job, detected by the detecting section, is to be implemented by the processing section.

4. The printing apparatus of claim 3,
wherein the acquiring section writes the suitability level into the storage device, and compares the suitability level with other suitability levels written into the storage device by other ones of the plural printing apparatuses, so as to determine whether or not the print job, detected by the detecting section, is to be implemented by the processing section; and
wherein, when determining that the suitability level is higher than the other suitability levels, the acquiring section acquires the print job, detected by the detecting section, from the storage device.

5. The printing apparatus of claim 3,
wherein the acquiring section compares the suitability level with a predetermined reference level, so as to determine whether or not the print job, detected by the detecting section, is to be implemented by the processing section; and
wherein, when determining that the suitability level is higher than the predetermined reference level, the acquiring section acquires the print job, detected by the detecting section, from the storage device.

6. The printing apparatus of claim 3,
wherein the processing section includes:
a printing section that implements a print processing operation to print an image, based on the print job, onto a recording medium, so as to output a printed recording medium onto which the image is printed; and
a post processing section that implements a post processing operation to apply a post processing, based on the print job, to the printed recording medium outputted by the printing section;
wherein the suitability level includes a first suitability level in regard to the print processing operation and a second suitability level in regard to the post processing operation.

7. The printing apparatus of claim 3,
wherein the print job includes processing conditions that specify processing contents of the print job concerned, and the processing conditions include a non-indispensable selecting condition, for which a setting operation to be conducted by the print instructing apparatus is acceptable; and
wherein the acquiring section finds the suitability level, based on the non-indispensable selecting condition included in the processing conditions of the print job and a function of the processing section.

8. The printing apparatus of claim 1,
wherein the detecting section accesses the storage device at such a timing when the processing section can implement a new job.

9. The printing apparatus of claim 1,
wherein the acquiring section instructs the storage device to delete the print job, acquired in advance by the acquiring section, from the storage device.

10. The printing apparatus of claim 1,
wherein the printing apparatus is provided with the storage device.

11. A printing system, comprising:
a print instructing apparatus that outputs a print job;
a storage device that receives the print job, outputted by the print instructing apparatus, so as to store the print job received, therein;
a plurality of printing apparatuses, each of which is capable of accessing the storage device to acquire the print job stored in the storage device, and of implementing the print job, and each of which comprises a detecting section to access to the storage device so as to detect the print job stored in the storage device, an acquiring section to acquire the print job detected by the detecting section from the storage device, and a processing section to implement the print job acquired by the acquiring section, wherein the acquiring section conducts a determining operation for determining whether or not the print job, detected by the detecting section, is to be implemented by the processing section; and
a control section, which is provided in either the print instructing apparatus or each of the plurality of printing apparatuses, to display a single or plural result/results of the determining operation that has been conducted for the print job, stored in the storage device, by at least one of the plurality of printing apparatuses, with information thereof, so as to make the print instructing apparatus accept a user's selecting operation for selecting a printing apparatus that implements the print job from the single or plural result/results, and to make the storage device store a result of the user's selecting operation therein;
wherein, among the printing apparatuses that conducted the determining operation, a specific printing apparatus, which has confirmed that the specific printing apparatus has been selected from the result of the user's selecting operation stored in the storage device, acquires the print job detected by the detecting section from the storage device.

12. The printing system of claim 11,
wherein the acquiring section finds a suitability level in a case that the processing section implements the print job detected by the detecting section, so as to employ the suitability level for determining whether or not the print job, detected by the detecting section, is to be implemented by the processing section.

13. The printing system of claim 11,
wherein the control section makes the print instructing apparatus display information of a printing apparatus that fulfills a predetermined condition among the printing apparatuses that conducted the determining operation.
